(19) United States
(12) Patent Application Publication
(10) Pub. No.: US 2024/0326169 A1
(43) Pub. Date: Oct. 3, 2024

(54) LASER WELDING METHOD

(71) Applicant: KABUSHIKI KAISHA TOSHIBA, Tokyo (JP)

(72) Inventors: Go OBARA, Setagaya (JP); Takashi OBARA, Yokohama (JP)

(73) Assignee: KABUSHIKI KAISHA TOSHIBA, Tokyo (JP)

(21) Appl. No.: 18/602,263

(22) Filed: Mar. 12, 2024

(30) Foreign Application Priority Data
Mar. 27, 2023 (JP) 2023-050491

(51) Int. Cl. B23K 26/244; B23K 20/10

(52) U.S. Cl. CPC B23K 26/244; B23K 20/10

(57) ABSTRACT

A laser welding method includes a preparation process and a welding process. The preparation process including preparing a joining member in which a second member is joined to a first member. The welding process includes welding the second member to the first member by irradiating a laser beam on the joining member. The first member includes a first base member and a first oxide film. The second member includes a second base member and a second oxide film. The preparation process includes removing the first and second oxide films and joining the second base member to the first base member by ultrasonically vibrating the first and second members. The welding process includes welding the second base member to the first base member by irradiating the laser beam on a portion at which the second base member is joined to the first base member.

### CROSS-REFERENCE TO RELATED APPLICATIONS

This application is based upon and claims the benefit of priority from Japanese Patent Application No. 2023-050491, filed on Mar. 27, 2023; the entire contents of which are incorporated herein by reference.

### FIELD

Embodiments described herein relate generally to a laser welding method.

### BACKGROUND

There is a laser welding method that welds multiple members by irradiating a laser beam. In the laser welding method, for example, the multiple members are welded by irradiating a laser beam after temporarily fixing the multiple members.

In such a laser welding method, there is a risk that bubbles included in the members may become large if the heat amount input in the temporary fixation and/or laser beam irradiation is high. If the bubbles included in the member become large, there is a risk that spatter from the members may occur in the laser beam irradiation; and joining defects may occur. Also, if the bubbles included in the members become large, there is a risk that leakage defects due to the bubbles may occur.

### BRIEF DESCRIPTION OF THE DRAWINGS

FIGS. 1A to 1C are perspective views illustrating a laser welding method according to a first embodiment;

FIG. 2 is a plan view illustrating a weld portion of the laser welding method according to the first embodiment;

FIGS. 3A and 3B are explanatory drawings describing the preparation process and the welding process according to the embodiment;

FIGS. 4A to 4C are explanatory drawings describing the joining by ultrasonic vibration;

FIGS. 5A to 5C are perspective views illustrating a laser welding method according to a second embodiment; and

FIG. 6 is a plan view illustrating a weld portion of the laser welding method according to the second embodiment.

### DETAILED DESCRIPTION

A laser welding method according to an embodiment welds a second member to a first member by irradiating a laser beam. The laser welding method according to the embodiment includes a preparation process and a welding process. The preparation process includes preparing a joining member in which the second member is joined to the first member. The welding process includes welding the second member to the first member by irradiating a laser beam on the joining member. The first member includes a first base member, and a first oxide film formed at a surface of the first base member. The second member includes a second base member, and a second oxide film formed at a surface of the second base member. The preparation process includes removing the first and second oxide films and joining the second base member to the first base member by ultrasonically vibrating the first and second members in a state in which the second member overlaps the first member so that the first oxide film and the second oxide film are in contact. The welding process includes welding the second base member to the first base member by irradiating the laser beam on a portion at which the second base member is joined to the first base member.

Exemplary embodiments will now be described with reference to the drawings.

The drawings are schematic or conceptual; and the relationships between the thickness and width of portions, the proportional coefficients of sizes among portions, etc., are not necessarily the same as the actual values thereof. Furthermore, the dimensions and proportional coefficients may be illustrated differently among drawings, even for identical portions.

In the specification of the application and the drawings, components similar to those described in regard to a drawing thereinabove are marked with like reference numerals; and a detailed description is omitted as appropriate.

### First Embodiment

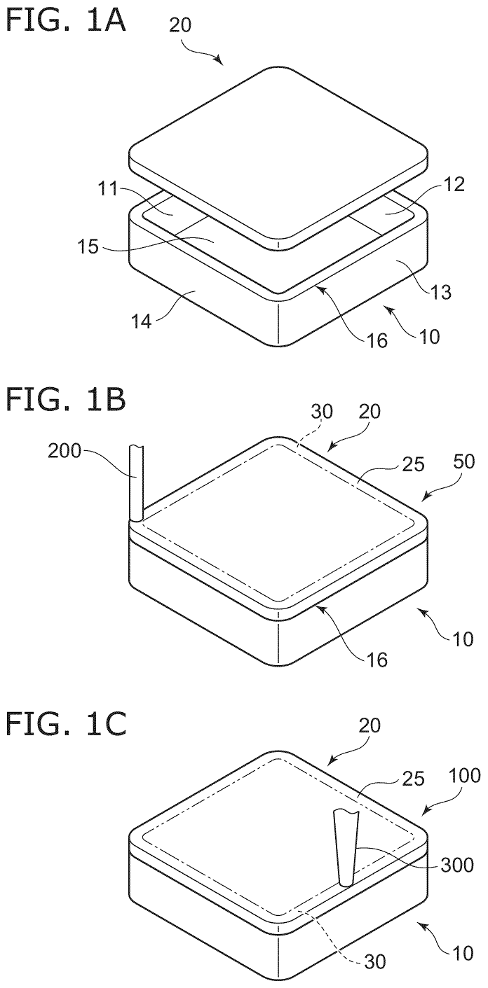

FIGS. 1A to 1C are perspective views illustrating a laser welding method according to a first embodiment.

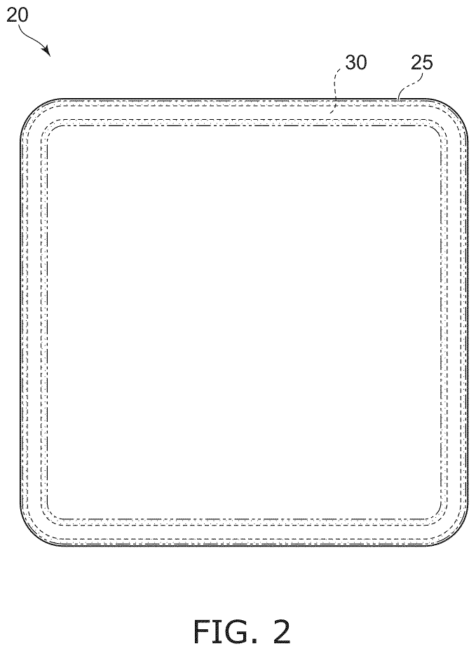

FIG. 2 is a plan view illustrating a weld portion of the laser welding method according to the first embodiment.

As illustrated in FIGS. 1A to 1C, the laser welding method according to the embodiment includes a preparation process and a welding process.

In the laser welding method according to the embodiment, first, the preparation process is performed. In the preparation process, first, as illustrated in FIGS. 1A and 1B, a first member 10 and a second member 20 to be welded are prepared.

The first member 10 and the second member 20 include, for example, at least one of aluminum, magnesium, or copper. For example, it is favorable for the first and second members 10 and 20 to include aluminum. The material of the second member 20 may be the same as or different from the material of the first member 10.

The first member 10 is, for example, a housing that has an opening part 16. For example, the first member 10 has a substantially rectangular box-shaped structure that is open upward. The first member 10 includes, for example, a first side surface part 11, a second side surface part 12, a third side surface part 13, a fourth side surface part 14, and a bottom surface part 15. The bottom surface part 15 is positioned at the bottom part of the first member 10. The first side surface part 11, the second side surface part 12, the third side surface part 13, and the fourth side surface part 14 each are upright parts that rise upward from the bottom surface part 15. The first side surface part 11 and the third side surface part 13 face each other. The second side surface part 12 and the fourth side surface part 14 face each other. For example, the first member 10 has the opening part 16 formed of the upper end of the first side surface part 11, the upper end of the second side surface part 12, the upper end of the third side surface part 13, and the upper end of the fourth side surface part 14.

The second member 20 is, for example, a lid that covers the opening part 16 of the first member 10. For example, the second member 20 has a flat-plate structure. As illustrated in FIG. 2, the second member 20 includes a weld portion 25. In FIG. 2, the weld portion 25 is illustrated by cross hatching. The weld portion 25 is the portion that is welded with the first member 10 in the welding process. For example, the weld portion 25 is the portion on which a laser beam 300 is irradiated in the welding process. The weld portion 25 is located in a portion of the second member 20 overlapping the first member 10. In the example, the weld portion 25 is located at the position at which the opening part 16 and the second member 20 (the lid) overlap.

Although the first member 10 is a housing and the second member 20 is a lid in the example described herein, the shapes of the first and second members 10 and 20 are not limited to such shapes. It is sufficient that the shapes of the first and second members 10 and 20 can be welded by laser irradiation. For example, the first member 10 and the second member 20 each may have flat plate shapes.

Then, in the preparation process as illustrated in FIG. 1B, a joining member 50 is prepared in which the second member 20 is joined to the first member 10. The joining member 50 has a structure in which the second member 20 is welded to the first member 10 via a connection portion 30 arranged along the weld portion 25. That is, in the joining member 50, the first member 10 and the second member 20 are joined via the connection portion 30. According to the embodiment as described below, the connection portion 30 is a portion at which the first member 10 (a first base member 10a) and the second member 20 (a second base member 20a) are joined (connected) by ultrasonic vibration.

In the example as illustrated in FIG. 2, the preparation process includes continuously joining the entire perimeter of the overlapping portion of the lid (the second member 20) and the opening part 16 of the housing (the first member 10). That is, in the example, the connection portion 30 is continuous over the entire perimeter of the weld portion 25. In other words, the lid (the second member 20) and the opening part 16 of the housing (the first member 10) are continuously joined over the entire perimeter.

Then, in the laser welding method according to the embodiment, the welding process is performed. The welding process is performed after the preparation process. As illustrated in FIG. 1C, the welding process includes welding the second member 20 to the first member 10 by irradiating the laser beam 300 along the weld portion 25 of the joining member 50. As a result, for example, as illustrated in FIG. 2B, a sealed member 100 is manufactured in which the opening part 16 of the first member 10 (the housing) is sealed by the second member 20 (the lid).

The laser device that irradiates the laser beam 300 used in the welding process may be, for example, a pulsed laser that produces a pulsed output at a certain repetition frequency (pulse width), or may be a CW (Continuous Wave) laser that continuously produces a certain output. In the case of a pulsed laser, the pulse width is, for example, several femtoseconds or several picoseconds. The wavelength of the laser beam 300 is, for example, not less than 300 nm and not more than 1070 nm.

The preparation process and the welding process will now be described in more detail.

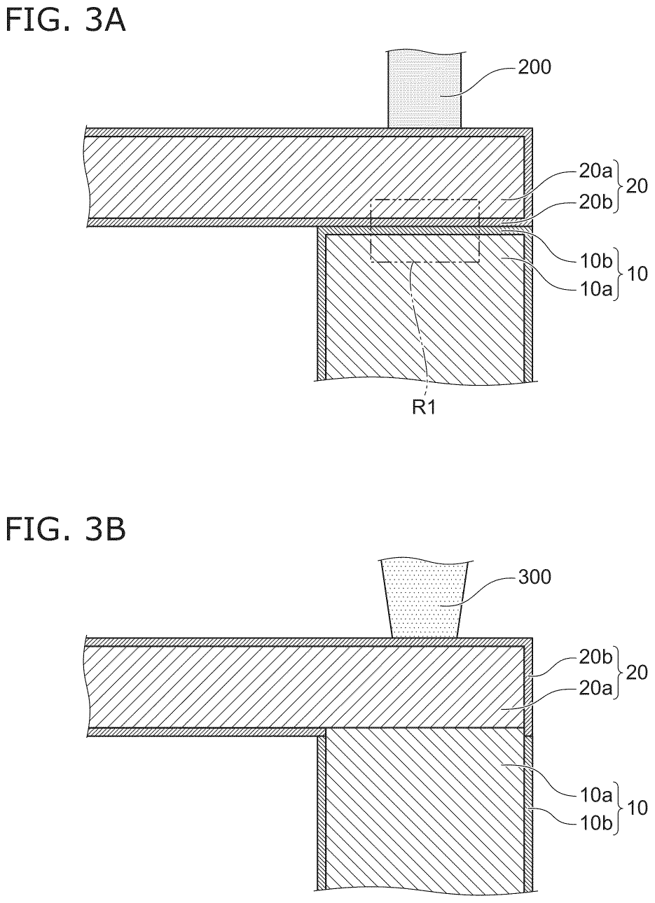

FIGS. 3A and 3B are explanatory drawings describing the preparation process and the welding process according to the embodiment.

As illustrated in FIGS. 3A and 3B, the first member 10 includes the first base member 10a, and a first oxide film 10b formed at the surface of the first base member 10a. The first base member 10a includes a metal. The first oxide film 10b is, for example, a native oxide film. The second member 20 includes the second base member 20a, and a second oxide film 20b formed at the surface of the second base member 20a. The second base member 20a includes a metal. The second oxide film 20b is, for example, a native oxide film. Thus, oxide films (the first oxide film 10b and the second oxide film 20b) are formed at the surfaces of the first and second members 10 and 20.

For example, when the first member 10 and the second member 20 include aluminum, the first base member 10a and the second base member 20a are made of mainly aluminum. For example, when the first member 10 and the second member 20 include aluminum, the first oxide film 10b and the second oxide film 20b are made of mainly aluminum oxide.

The melting point of aluminum oxide (2072° C.) is higher than the melting point of aluminum (660° C.), and so it is necessary to heat to about 2000° C., which is near the melting point of aluminum oxide, in the laser beam irradiation to weld the second member 20 to the first member 10 when oxide films (the first oxide film 10b and/or the second oxide film 20b) are formed at the surfaces of the base members (the first base member 10a and/or the second base member 20a).

In the laser welding method, for example, the multiple members are welded by irradiating a laser beam after the multiple members are temporarily fixed. Conventionally, the temporary fixation is performed by a technique such as temporary welding by irradiating a laser beam, etc.

If, however, the heat amount input in the temporary fixation and/or laser beam irradiation is high, there is a risk that bubbles included in the members may become large. If the bubbles included in the members become large, there is a risk that spatter from the members in the laser beam irradiation may occur, and joining defects may occur. Also, if the bubbles included in the members become large, there is a risk that leakage defects due to the bubbles may occur.

Therefore, according to the embodiment as illustrated in FIG. 3A, the preparation process includes ultrasonically vibrating the first member 10 and the second member 20 in a state in which the second member 20 overlaps the first member 10 so that the first oxide film 10b and the second oxide film 20b are in contact. As a result, the first oxide film 10b and the second oxide film 20b are removed, and the second base member 20a is directly joined to the first base member 10a. Then, as illustrated in FIG. 3B, the welding process includes welding the second base member 20a to the first base member 10a by irradiating the laser beam 300 on the portion at which the second base member 20a is joined to the first base member 10a.

Thus, in the preparation process, the second base member 20a can be directly joined to the first base member 10a by removing the first oxide film 10b and the second oxide film 20b by ultrasonic vibration. As a result, the joining member 50 in which the second member 20 is joined to the first member 10 can be prepared even when temporary welding by irradiating a laser beam is not performed. Accordingly, compared to when temporary welding is performed by irradiating a laser beam, the heat input amount of the preparation process can be low. As a result, large bubbles included in the first and second members 10 and 20 can be suppressed, and joining defects and leakage defects can be suppressed.

By removing the first oxide film 10b and the second oxide film 20b in the preparation process, the welding process can weld the second member 20 to the first member 10 even without heating to a temperature near the melting point of the first and second oxide films 10b and 20b (by heating only to a temperature near the melting point of the first and second base members 10a and 20a). More specifically, for example, when the first member 10 and the second member 20 include aluminum, the preparation process can weld the second member 20 to the first member 10 even without heating to about 2000° C., which is near the melting point of aluminum oxide (by heating only to about 600° C., which is near the melting point of aluminum). Accordingly, compared to when temporary welding is performed by irradiating a laser beam without joining by ultrasonic vibration, the heat input amount of the welding process can be low. As a result, large bubbles included in the first and second members 10 and 20 can be suppressed, and joining defects and leakage defects can be suppressed.

In the welding method according to the embodiment, the welding process includes irradiating the laser beam 300 on the portion at which the second base member 20a is joined to the first base member 10a. That is, ultrasonic vibration in the preparation process is performed on at least a portion where the laser beam 300 will be irradiated in the welding process. In other words, the portion that is ultrasonically vibrated in the preparation process overlaps at least a portion where the laser beam 300 is irradiated in the welding process. As a result, for example, compared to when the portion ultrasonically vibrated in the preparation process and the portion irradiated by the laser beam 300 in the welding process are different (do not overlap), large bubbles included in the first and second members 10 and 20 can be suppressed, and joining defects and leakage defects can be suppressed.

An ultrasonic vibration device is used as a device that ultrasonically vibrates the first member 10 and the second member 20. For example, the ultrasonic vibration device ultrasonically vibrates the first member 10 and the second member 20 by vibrating an anvil 200 mounted in contact with the second member 20 at a high speed. For example, the anvil 200 of the ultrasonic vibration device may be mounted in contact with the first member 10, or may be mounted in contact with both the first and second members 10 and 20.

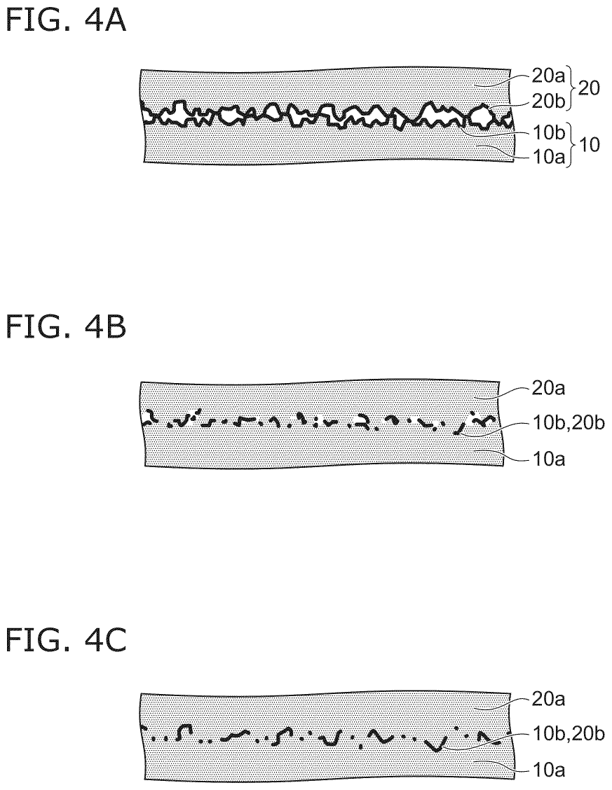

FIGS. 4A to 4C are explanatory drawings describing the joining by ultrasonic vibration.

FIGS. 4A to 4C are enlarged views of region R1 shown in FIG. 3A.

Before performing the ultrasonic vibration as illustrated in FIG. 4A, the first oxide film 10b is formed at the surface of the first base member 10a; and the second oxide film 20b is formed at the surface of the second base member 20a. That is, before performing the ultrasonic vibration, the first base member 10a and the second base member 20a are separated by the first and second oxide films 10b and 20b. In other words, before performing the ultrasonic vibration, the first base member 10a and the second base member 20a are not in direct contact.

When starting the ultrasonic vibration as illustrated in FIG. 4B, a portion of the first oxide film 10b and a portion of the second oxide film 20b are broken down and removed by the ultrasonic vibration. By removing the portion of the first oxide film 10b and the portion of the second oxide film 20b, the first base member 10a and the second base member 20a that were separated by the first and second oxide films 10b and 20b directly contact each other.

After performing the ultrasonic vibration as illustrated in FIG. 4C, the first base member 10a and the second base member 20a are joined in a state of being in direct contact. Therefore, as described above, the welding process can weld the second member 20 to the first member 10 even without heating to a temperature near the melting point of the first and second oxide films 10b and 20b (by heating only to a temperature near the melting point of the first and second base members 10a and 20a).

In the laser welding method according to the first embodiment, the preparation process may include temporary welding by irradiating a laser beam in addition to the ultrasonic vibration described above. By temporarily welding by irradiating a laser beam, for example, the joining member 50 in which the second member 20 is more securely joined to the first member 10 can be prepared.

In such a case, it is favorable to perform the joining by ultrasonic vibration before the temporary welding. By performing the joining by ultrasonic vibration before the temporary welding, the heat input amount when temporarily welding can be reduced; therefore, compared to when temporary welding is performed by irradiating a laser beam without joining by ultrasonic vibration, the heat input amount of the preparation process can be reduced. Accordingly, large bubbles included in the first and second members 10 and 20 can be suppressed, and joining defects and leakage defects can be suppressed.

### Second Embodiment

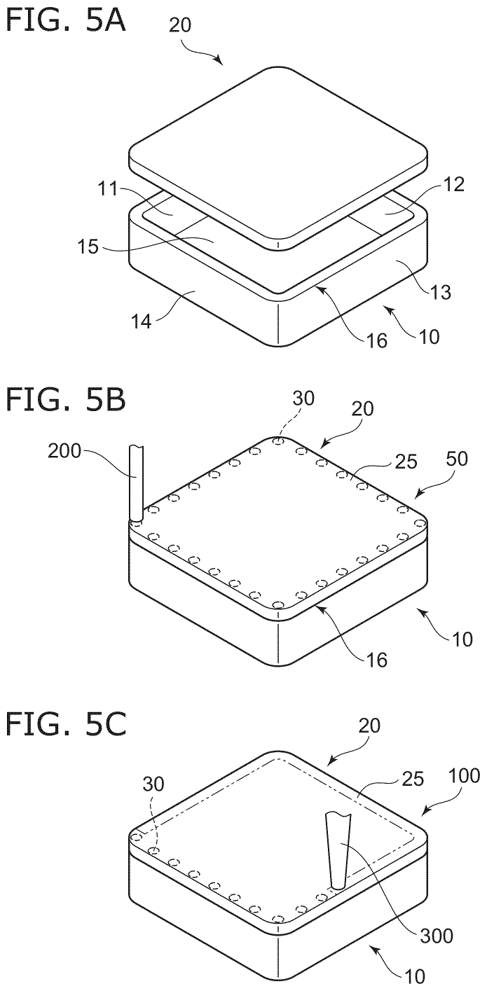

FIGS. 5A to 5C are perspective views illustrating a laser welding method according to a second embodiment.

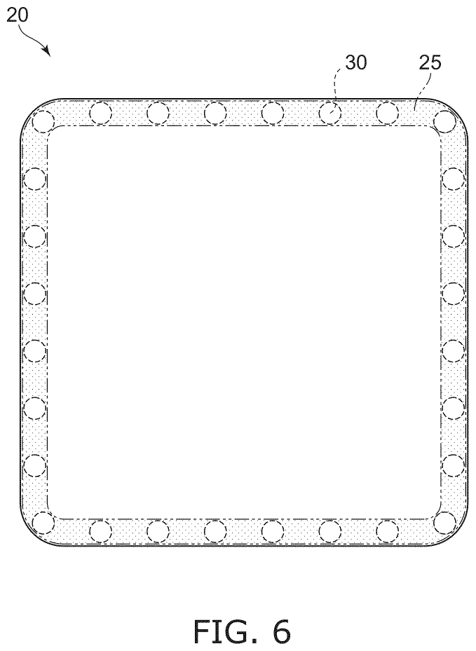

FIG. 6 is a plan view illustrating a weld portion of the laser welding method according to the second embodiment.

In the laser welding method according to the second embodiment as illustrated in FIGS. 5A to 5C and FIG. 6, the preparation process includes discontinuously joining the entire perimeter of the overlapping portion of the lid (the second member 20) and the opening part 16 of the housing (the first member 10) at multiple spots. Otherwise, the laser welding method according to the second embodiment is substantially the same as the laser welding method according to the first embodiment.

That is, in the example, the connection portions 30 are provided to be discontinuous at multiple spots over the entire perimeter of the weld portion 25. In other words, the lid (the second member 20) and the opening part 16 of the housing (the first member 10) are discontinuously joined over the entire perimeter. In the example, the connection portions 30 are arranged at uniform spacing around the entire perimeter of the weld portion 25. The spacing between the multiple connection portions 30 may not be uniform spacing.

In the example as well, by performing ultrasonic vibration in the preparation process, the first oxide film 10b and the second oxide film 20b can be removed, and the second base member 20a can be directly joined to the first base member 10a. As a result, the joining member 50 in which the second member 20 is joined to the first member 10 can be prepared even without performing temporary welding by irradiating a laser beam. Accordingly, compared to when temporary welding is performed by irradiating a laser beam, the heat input amount of the preparation process can be reduced. As a result, large bubbles included in the first and second members 10 and 20 can be suppressed, and joining defects and leakage defects can be suppressed.

Embodiments may include the following configurations.

### Configuration 1

A laser welding method of welding a second member to a first member by irradiating a laser beam, the method comprising:
a preparation process of preparing a joining member in which the second member is joined to the first member; and
a welding process of welding the second member to the first member by irradiating a laser beam on the joining member,
the first member including
   a first base member, and
   a first oxide film formed at a surface of the first base member,
the second member including
   a second base member, and
   a second oxide film formed at a surface of the second base member,
the preparation process including removing the first and second oxide films and joining the second base member to the first base member by ultrasonically vibrating the first and second members in a state in which the second member overlaps the first member so that the first oxide film and the second oxide film are in contact,
the welding process including welding the second base member to the first base member by irradiating the laser beam on a portion at which the second base member is joined to the first base member.

### Configuration 2

The method according to configuration 1, wherein
the first member is a housing having an opening part,
the second member is a lid covering the opening part, and
the housing and the lid are welded at a position at which the opening part and the lid overlap.

### Configuration 3

The method according to configuration 2, wherein
the preparation process includes continuously joining an entire perimeter of an overlapping portion of the opening part and the lid, and
the welding process includes continuously irradiating the laser beam on the entire perimeter of the overlapping portion of the opening part and the lid.

### Configuration 4

The method according to configuration 2, wherein
the preparation process includes joining, discontinuously at a plurality of spots, an entire perimeter of an overlapping portion of the opening part and the lid, and
the welding process includes continuously irradiating the laser beam on the entire perimeter of the overlapping portion of the opening part and the lid.

### Configuration 5

The method according to any one of configurations 1 to 4, wherein
the first member and the second member include aluminum.

Thus, according to embodiments, a laser welding method is provided in which joining defects and leakage defects can be suppressed.

For example, the laser welding methods according to embodiments are favorably used to manufacture devices such as secondary batteries, heat exchangers such as heat sinks or the like, gas generators used in airbags or the like, air conditioner rotors, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions. Embodiments described above can be implemented in combination with each other.

What is claimed is:

1. A laser welding method of welding a second member to a first member by irradiating a laser beam, the method comprising:
a preparation process of preparing a joining member in which the second member is joined to the first member; and
a welding process of welding the second member to the first member by irradiating a laser beam on the joining member,
the first member including
a first base member, and
a first oxide film formed at a surface of the first base member,
the second member including
a second base member, and
a second oxide film formed at a surface of the second base member,
the preparation process including removing the first and second oxide films and joining the second base member to the first base member by ultrasonically vibrating the first and second members in a state in which the second member overlaps the first member so that the first oxide film and the second oxide film are in contact,
the welding process including welding the second base member to the first base member by irradiating the laser beam on a portion at which the second base member is joined to the first base member.

2. The method according to claim 1, wherein
the first member is a housing having an opening part,
the second member is a lid covering the opening part, and
the housing and the lid are welded at a position at which the opening part and the lid overlap.

3. The method according to claim 2, wherein
the preparation process includes continuously joining an entire perimeter of an overlapping portion of the opening part and the lid, and
the welding process includes continuously irradiating the laser beam on the entire perimeter of the overlapping portion of the opening part and the lid.

4. The method according to claim 2, wherein
the preparation process includes joining, discontinuously at a plurality of spots, an entire perimeter of an overlapping portion of the opening part and the lid, and
the welding process includes continuously irradiating the laser beam on the entire perimeter of the overlapping portion of the opening part and the lid.

5. The method according to claim 1, wherein
the first member and the second member include aluminum.
